(19) United States
(12) Patent Application Publication
(10) Pub. No.: US 2011/0016047 A1
(43) Pub. Date: Jan. 20, 2011

(54) FINANCIAL TRANSACTION SYSTEM, AUTOMATED TELLER MACHINE (ATM), AND METHOD FOR OPERATING AN ATM

(75) Inventors: Miin Chyou Wu, Hsinchu (TW); Shaw Wen Huang, Hsinchu (TW); Wei Chen Lin, Hsinchu (TW); Yvette E-Wen Lin, Hsinchu (TW); Yu Chun Hsieh, Hsinchu (TW); Chung Pei Hung, Hsinchu (TW)

Correspondence Address: LIU & LIU, 444 S. FLOWER STREET SUITE 1750, LOS ANGELES, CA, 90071, US

(73) Assignee: MXTRAN INC., Hsinchu (TW)

(21) Appl. No.: 12/837,448

(22) Filed: Jul. 15, 2010

(30) Foreign Application Priority Data
Jul. 16, 2009 (TW) 098124058

(51) Int. Cl. G06Q 40/00

(52) U.S. Cl. 705/43

(57) ABSTRACT

A financial transaction system is provided. The financial transaction system includes a server and at least one automated teller machine (ATM). In response to a request from a user, the server issues a one-time password (OTP) to the user's mobile device. The ATM receives an OTP from the user and sends the received OTP to the server for verification, in order to perform a financial transaction operation.

### BACKGROUND OF THE INVENTION

1. Technical Field

The present invention relates to a financial transaction system and an automated teller machine (ATM).

2. Description of Related Art

In order to make a money withdrawal or transfer via a bank's automated teller machine (ATM), it is conventionally required to first insert an ATM card and then enter a password into the ATM. The ATM compares the password entered by the user with passwords previously stored in the ATM card, and if a match is found, the user is allowed to make the withdrawal or transfer. However, keeping ATM cards safe and remembering passwords cause inconvenience in use and raise transaction security issues.

U.S. Pat. No. 6,045,039 proposes cardless ATMs whereby a user's identity is confirmed by the user's biometric information, but the ATMs require a database for storing all the users' biometric information.

Likewise, to dispense with the conventional ATM cards, US Patent Application Publication No. 2006/0136634 proposes a method for transferring funds or checking account balances by a mobile device (such as a mobile phone). Also, U.S. Pat. No. 7,198,199 proposes a slave card externally connected to the SIM card of a mobile phone such that, by virtue of a SIM Tool Kit (STK) application installed on the mobile phone, a user can make a transfer through the mobile phone directly. US Patent Application Publication No. 2007/0220597 proposes a verification system comprising a Web browser installed on a personal computer, wherein a one-time password is entered by means of the Web browser to perform identity verification with respect to intended online services.

With the aforesaid three techniques, identity verification is carried out without using any conventional ATM cards or magnetic cards. However, a common drawback of the aforesaid three techniques is that they fail to meet users' basic need for withdrawing cash or collecting physical goods.

### BRIEF SUMMARY OF THE INVENTION

Embodiments of the present invention relate to financial transaction systems, such as a banking system that provides banking services including transfer, withdrawal, cash advance, etc. and, more particularly, to a financial transaction system connected to conventional automated teller machines (ATMs). However, the financial transaction system in the embodiment of the present invention may also include point of sale (POS) systems for selling negotiable tickets (such as train tickets) or any physical goods. Another embodiment of the present invention relates to transaction systems whereby user identity is verified and services are offered to users by means of the ATMs installed in public places.

The ATMs in the embodiments of the present invention include not only ATMs provided by banks but also POS systems for selling negotiable tickets or any physical goods. Unlike a typical personal computer, an ATM is always installed in a public place and intended to be used by non-specific persons at non-specific time. In general, ATMs are not owned or managed by users; hence, user-operable functions of ATMs are specified by ATM operator in advance.

Embodiments of the present invention have a feature as follows: a user of an ATM has to enter a one-time password (OTP) (also known as a dynamic password) into the ATM, and then the ATM sends the OTP to a server for verification. As the OTP becomes invalidated upon verification, the user is not confronted with the drawbacks and risks associated with conventional ATM cards.

Embodiments of the present invention have another feature as follows: the server issues an OTP to the user's mobile device in advance, and the user, after being aware of the OTP thus issued, has to enter the OTP into the ATM within an effective period of the OTP (such as 10 minutes) in order to conduct a transaction, thereby further enhancing transaction security.

In an embodiment of the present invention, a financial transaction system includes a server and at least one ATM. The server issues an OTP to the user's mobile device in response to a request from the user, and thus the user gets aware of the OTP through the mobile device. The ATM is connected to the server and includes a password interface, a network module, and an execution module. The password interface receives an OTP from the user. The network module sends the OTP thus received to the server for verification and receives an acknowledgement (ACK) from the server. The execution module executes a financial transaction operation, such as making a withdrawal or transfer, or checking an account balance, in response to the ACK.

In another embodiment of the present invention, an ATM is connected to a server, and the server issues an OTP to the user. The ATM includes a password interface, a network module, and an execution module. The password interface receives an OTP from the user. The network module sends the OTP thus received to the server for verification and receives an ACK from the server. The execution module executes a specified operation, such as making a withdrawal or transfer, or checking an account balance, in response to the ACK. The execution module includes a physical object supplying device and thus supplies physical objects, such as cash, negotiable tickets, or other goods. The ATM may further include a prompt module with a predefined key. Once the user presses the key, the prompt module prompts the user, through a screen, to enter the OTP, thus allowing the user to conduct a transaction without using any ATM card.

In a further embodiment of the present invention, a method for operating an ATM includes the steps of: issuing by the server an OTP to a user's mobile device in response to a request from the user so as for the user to be aware of the OTP; receiving by the ATM the OTP entered by the user; sending by the ATM the OTP thus received to the server; verifying the OTP by the server, followed by sending an ACK to the ATM by the server; and executing by the ATM a specified operation in response to the ACK.

In the above embodiments, the specified operation executed by the ATM further includes supplying pre-stocked physical objects, wherein the physical objects are banknotes, negotiable tickets, or other goods.

The above features and advantages of the present invention can be better understood by reviewing the following description of some illustrative embodiments of the present invention and the appended claims.

### BRIEF DESCRIPTION OF THE SEVERAL VIEWS OF THE DRAWINGS

The present invention as summarized above will now be described with reference to the accompanying drawings of specific embodiments so as to demonstrate the subject matter and advantages of the present invention with additional clarity and details. However, it is to be understood that the embodiments disclosed herein are only the typical embodiments and are not intended to limit the scope of the present invention. In the drawings:

FIG. 1 is a schematic view of a financial transaction system in an embodiment of the present invention;

FIG. 2 is a schematic view of an automated teller machine (ATM) in an embodiment of the present invention;

FIG. 3 is the flowchart of a method for operating an ATM in an embodiment of the present invention; and

FIG. 3A through FIG. 3C show screen images of a user's mobile device in an embodiment of the present invention.

### DETAILED DESCRIPTION OF THE INVENTION

Persons skilled in the art should understand that the present invention can be implemented in the form of a device, a method, or a machine-usable medium. Hence, the present invention can come in various forms, such as a complete hardware embodiment, a complete software embodiment (including firmware, routine software, micro-code, etc.), or a combination of software and hardware which is referred to as a “module” or “system” hereunder.

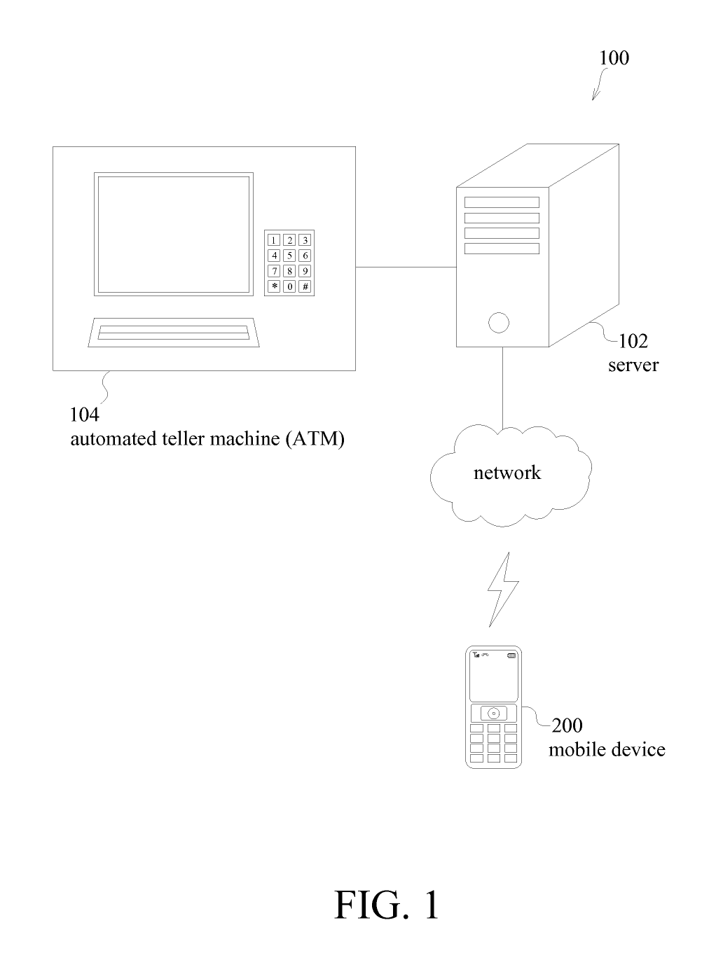

FIG. 1 shows a schematic view of a financial transaction system 100 in an embodiment of the present invention. The financial transaction system 100 includes a server 102 and an automated teller machine (ATM) 104. In this embodiment, the server 102 and the ATM 104 are provided in an existing ATM network owned by a bank; hence, the server 102 and the ATM 104 have dedicated connection, so as to ensure transaction security. Alternatively, the server 102 and the ATM 104 are independent of an existing ATM network owned by a bank. As shown in FIG. 1, the server 102 is connected to a mobile device 200 (such as a mobile phone or a personal digital assistant (PDA)) such that the server 102 and the mobile device 200 can communicate with each other via the Internet and/or a mobile phone network.

With its built-in application program or a SIM Tool Kit (STK), the mobile device 200 can log in the server 102. However, prior to the log-in, it may be necessary to enter the user's username and a default password into the mobile device 200, as disclosed in US Patent Application Publication No. 2006/0136634. The password entered into the mobile device 200 only serves the purpose of logging in the server 102 and is therefore different in purpose from the one-time password (OTP) that is later required to be entered into the ATM 104.

In this embodiment, the server 102 is further connected to a username database (not shown). The username database is maintained by a bank and stored with data related to users' usernames, so as to enable enquires about username-related data. After logging in the server 102, the user can request the server 102, by means of the mobile device 200, for an OTP for later use with the ATM 104. Then, the server 102 generates the requested OTP for the user's username and sends the OTP to the mobile device 200 (for example, by SMS). The OTP has an effective period or any other limitation of use. For example, the use of the OTP is restricted to ATMs 104 located in a specific city or ATMs 104 installed and maintained by a specific bank.

The ATM 104 includes a keyboard, a screen, a monitor, a banknote supplying device, and a receipt printing device (not shown in FIG. 1) in the same way as conventional ATMs, such as the conventional ATMs manufactured by NCR (http://www.ncr.com/), Diebold (http://www.diebold.com/), or Wincor Nixdorf (http://www.wincor-nixdorf.com/).

The present invention does not impose any restriction upon the quantity of the server 102 and the ATM 104. However, to facilitate the description of the present invention, FIG. 1 shows only one server 102 and one ATM 104. Preferably, one server 102 is sufficient to support two or more ATMs 104.

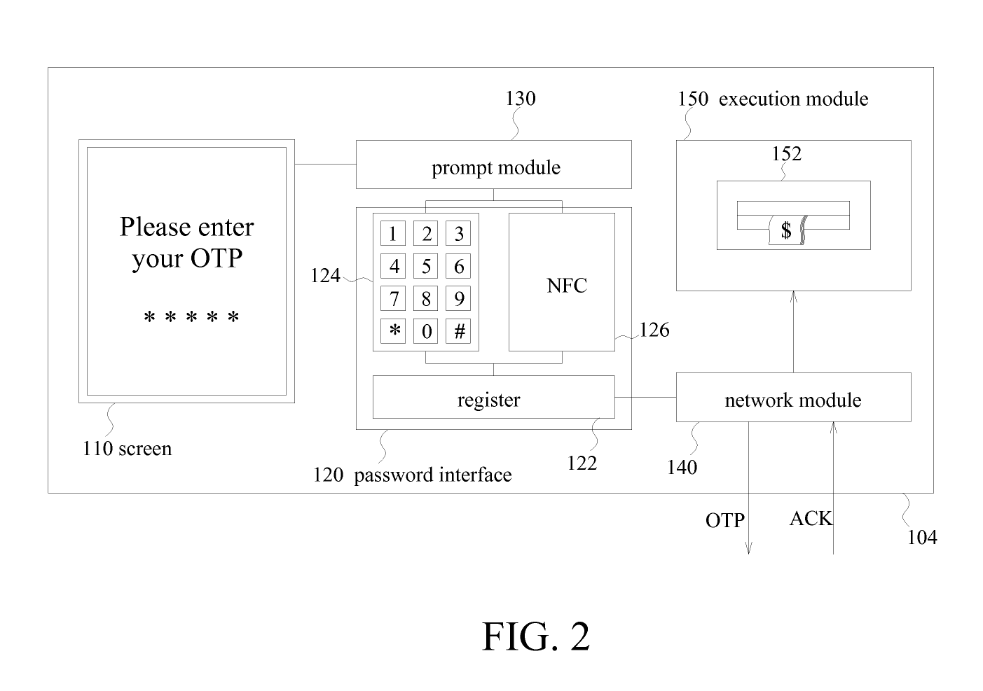

Referring to FIG. 2, the ATM 104 includes a screen 110 and a password interface 120. The password interface 120 has a register 122 (such as DRAM) and an input device 124 (such as a keyboard). The user enters a password with the input device 124 and temporarily stores the password in the register 122. In contrast to the conventional ATM, which usually requires that the user insert an ATM card into the ATM to start an ensuing operation (for example, entering a password), the ATM 104 further includes a prompt module 130 connected to the screen 110 and the input device 124, and once the user calls the prompt module 130, using the input device 124 (such as a specific key of the keyboard), the prompt module 130 enters a special mode in which the prompt module 120 prompts the user, through the screen 110, to enter an OTP. The user, after receiving the OTP through the mobile device 200, enters the OTP with the input device 124 and temporarily stores the OTP in the register 122. In this embodiment, it is not necessary for the user to use any conventional ATM cards.

In another embodiment, the password interface 120 further includes a near field communication (NFC) interface 126. In cases where the mobile device 200 supports NFC functionality, the user can sends the OTP directly to the password interface 120 via the mobile device 200 in a wireless or non-contact manner; hence, it is not necessary for the user to enter the OTP with the input device 124 manually. In consequence, bystanders are prevented from catching a stealthy glimpse of the OTP, and transaction security is enhanced. It is also feasible for the user to call the prompt module 130 via the NFC interface 126 by using the mobile device 200.

The ATM 104 further includes a network module 140 for sending the OTP entered by the user and temporarily stored in the register 122 to the server 102 via a dedicated connection. The server 102 verifies the OTP thus received and, upon successful verification of the OTP, sends an acknowledgement (ACK) to the ATM 104. Where an OTP has an effective period (such as 10 to 15 minutes), the correct OTP has to be sent to the server 102 for verification within the effective period so as for the verification to be successful. The hardware communication settings for the connection between the network module 140 and the server 102 are similar to those for the connection between a conventional ATM and a bank server; however, unlike the ATM 104 in the embodiments of the present invention, conventional ATMs seldom have sufficient security measures and thus never send passwords entered by users to a bank server for verification.

The ATM 104 further includes an execution module 150 for executing, upon receipt of the ACK from the server 102, an operation such as making a transfer or checking an account balance, according to instructions subsequently given to the ATM 104 by the user, and controlling a banknote supplying device 152 of the ATM 104 so as to supply banknotes to the user.

In another embodiment, the user, upon logging in the server 102, selects an intended transaction and informs the server 102 of the selection via the mobile device 200. The server 102, upon sending the ACK to the ATM 104, informs the ATM 104 of the transaction expected by the user and requests the execution module 150 to conduct the transaction, thereby sparing the user the hassle of having to perform a follow-up procedure on the ATM 104.

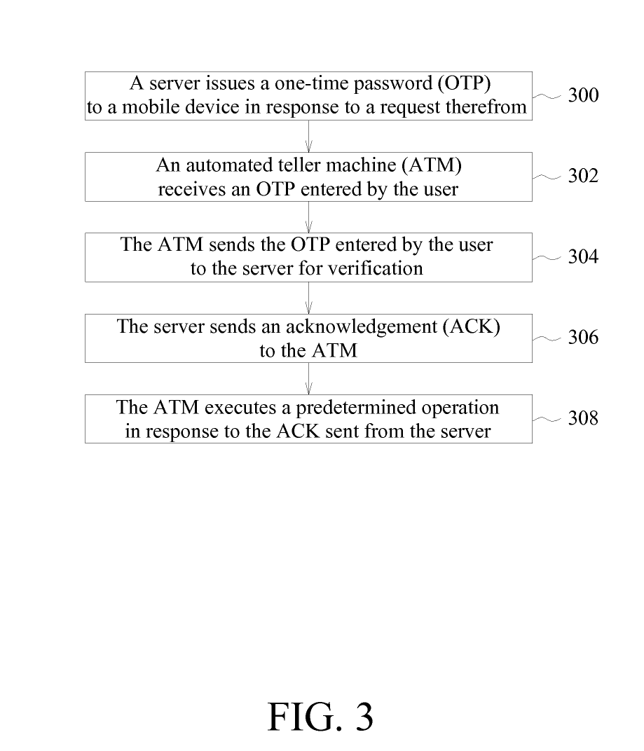

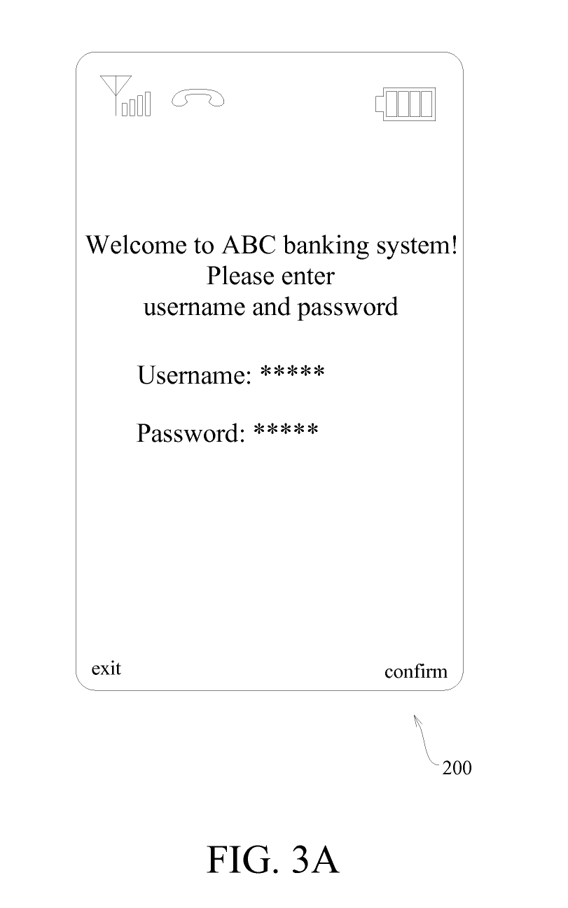

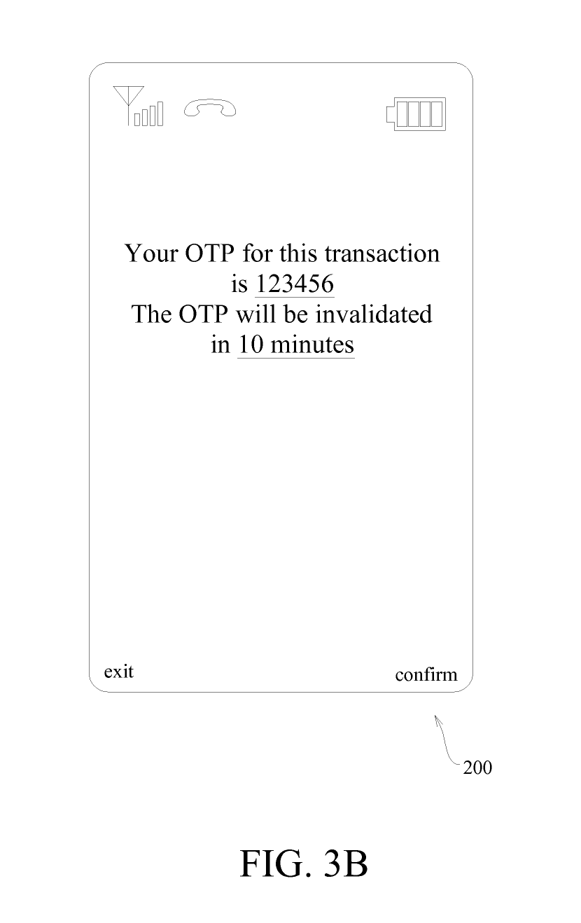

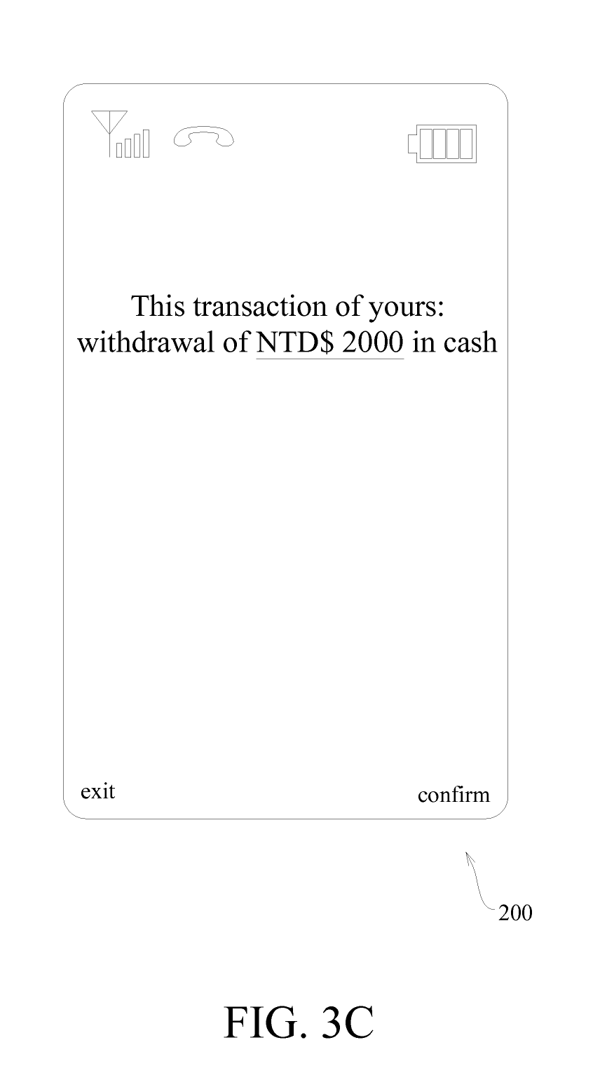

FIG. 3 illustrates a method for operating an ATM in an embodiment of the present invention. The present invention is hereunder described by reference to FIGS. 1, 2 and 3.

In step 300, the mobile device 200 logs in a banking transaction service system provided by the server 102 (with FIG. 3A showing the related screen image of the mobile device 200). Then, the server 102 issues an OTP to the mobile device 200 in response to a request from the mobile device 200 (with FIG. 3B showing the related screen image of the mobile device 200), as disclosed in detail in the afore-cited US Patent Application Publication No. 2006/0136634. In another embodiment, the user may also use a device other than the mobile device 200 to request the server 102 to issue an OTP to the mobile device 200.

In step 302, the user selects an ATM 104 at will or selects an ATM 104 (such as the ATM 104 located at a specific address) according to operation instructions sent to the mobile device 200 together with the OTP. The ATM 104 receives an OTP entered by the user. In this regard, the user enters the password by the input device 124 manually, by NFC, or by the mobile device 200. The user may call the prompt module 130 (as shown in FIG. 2) before entering the OTP. In that case, the user enters the OTP after a prompt message appears on the screen 110 of the ATM 104 (such as the screen 110 shown in FIG. 2).

In step 304, the ATM 104 sends the OTP entered by the user to the server 102 for verification. In step 306, the server 102 sends the ACK to the ATM 104. In step 308, the ATM 104 executes an operation (such as cash withdrawal) expected by the user, in response to the ACK received from the server 102. Afterward, the screen 110 shows the user a message indicting completion of the operation. Alternatively, the server 102 sends to the mobile device 200 the message indicting completion of the operation (with FIG. 3C showing the related screen image of the mobile device 200. Alternatively, the message indicting completion of the operation is sent to the mobile device 200 via the NFC interface 126.

Although the above embodiments apply to a financial transaction operation, persons skilled in the art should understand that the present invention also applies to any other transaction systems that involve identity verification, such as ticketing systems or point of sale (POS) systems for supplying physical goods.

The present invention can also be implemented in other specific ways without departing from the spirit or essential features of the present invention. The various aspects of the foregoing specific embodiments are to be taken as illustrative rather than restrictive. Hence, the scope of the present invention is defined by the appended claims rather than the above descriptions. All equivalents to the claims and modifications made within the claims should fall within the scope of the present invention.

What is claimed is:

1. An automated teller machine (ATM), disposed in a public place and connected to a server, the server issuing a one-time password (OTP) to a user, the ATM comprising:
a password interface for receiving an OTP entered by the user;
a network module for sending the OTP entered by the user to the server for verification and receiving an acknowledgement (ACK) from the server; and
an execution module for executing a specified operation in response to the ACK.

2. The ATM of claim 1, further comprising:
a prompt module for prompting the user to enter the OTP in response to the user's instruction.

3. The ATM of claim 1, wherein the execution module comprises:
a physical object supplying device for supplying pre-stocked physical objects in response to the ACK.

4. The ATM of claim 3, wherein the physical objects are banknotes or negotiable tickets.

5. The ATM of claim 1, wherein the password interface receives the OTP from the user's mobile device in a non-contact manner.

6. A method for operating an automated teller machine (ATM), the ATM being disposed in a public place and connected to a server, the method comprising steps of:
issuing by the server a one-time password (OTP) to a user's mobile device in response to a request from the user;
receiving by the ATM an OTP entered by the user;
sending by the ATM the OTP entered by the user to the server;
verifying by the server the OTP entered by the user, and sending an acknowledgement (ACK) to the ATM by the server; and
executing by the ATM a specified operation in response to the ACK.

7. The method of claim 6, wherein the specified operation involves supplying pre-stocked physical objects.

8. The method of claim 7, wherein the physical objects are banknotes or negotiable tickets.

9. The method of claim 6, wherein the step of receiving the OTP entered by the user further comprises receiving the OTP from the mobile device.

10. A financial transaction system, comprising:
a server for issuing a one-time password (OTP) to a user's mobile device in response to a request from the user; and
an automated teller machine (ATM) disposed in a public place and connected to the server, the ATM comprising:
a password interface for receiving an OTP entered by the user;
a network module for sending the OTP entered by the user to the server for verification and receiving an acknowledgement (ACK) from the server; and
an execution module for executing a financial transaction operation to supply banknotes in response to the ACK.
